(19) United States
(12) Patent Application Publication
(10) Pub. No.: US 2014/0112840 A1
(43) Pub. Date: Apr. 24, 2014

(54) Device For And Method Of Extracting A Fraction From A Biological Sample

(71) Applicant: WISCONSIN ALUMNI RESEARCH FOUNDATION, Madison, WI (US)

(72) Inventors: David J. Beebe, Monona, WI (US); Keil Regehr, Madison, WI (US)

(73) Assignee: Wisconsin Alumni Research Foundation, Madison, WI (US)

(21) Appl. No.: 13/657,980

(22) Filed: Oct. 23, 2012

(51) Int. Cl. G01N 1/31

(52) U.S. Cl. CPC G01N 1/31
USPC 422/527

(57) ABSTRACT

A device is provided for facilitating the isolation of a fraction from a biological sample. The biological sample includes non-desired material and a fraction-bound solid phase substrate. The device includes an input zone for receiving the biological sample therein and a second zone interconnected to the input zone by a channel. A force attracts the fraction-bound solid phase substrate and is movable along a path between a first position adjacent the input zone, a second position adjacent the channel, and a third position adjacent the second zone. The force has a generally arcuate edge for concentrating the fraction-bound solid phase substrate along the path. The force urges the fraction-bound solid phase substrate from the input zone, through the channel and into the second zone as the force moves from the first position to the third position.

### REFERENCE TO GOVERNMENT GRANT

This invention was made with government support under CA160344 awarded by the National Institutes of Health. The government has certain rights in the invention.

### FIELD OF THE INVENTION

The present invention relates generally to the extraction of a fraction from a biological sample, and in particular, to a device for and a method for more efficiently extracting a fraction from a biological sample containing cultured cells, tissue samples and other biological materials.

### BACKGROUND AND SUMMARY OF THE INVENTION

Effective isolation of a desired fraction (e.g. cells, nucleic acids, etc.) from a biological sample (e.g., cultured cells, tissue, viruses) is often an essential prerequisite for further processing of the fraction. By way of example, the isolation of a nucleic acid from a biological sample is necessary for the efficient downstream amplification, detection, and quantification of specific genetic sequences via quantitative polymerase chain reaction (qPCR). The extraction process requires lysing the cells with harsh extraction reagents, such as detergents or enzymes, thereby resulting in a mixture of nucleic acids, cellular debris and extraction reagents. The nucleic acids are then separated/purified from the cellular debris and extraction reagents using a variety of techniques (e.g. organic solvent extraction, chromatography, centrifugation, dialysis). These techniques can be very time-consuming, tedious, and often require multiple washing steps. By way of example, commercially-available nucleic acid isolation kits require approximately 15 minutes to over one hour to complete, largely due to the multiple washing steps required to sufficiently separate the nucleic acids from the cellular debris and extraction reagents. Consequently, it has been suggested that as much as 15% of all molecular biology research time is devoted to purification.

In view of the foregoing, various attempts have been made to reduce the time associated with isolating a desired fraction from a biological sample. By way of example, Beebe et al., United States Patent Application No. 20110213133 discloses a device and a method for facilitating extraction of a fraction from a biological sample. The biological sample includes non-desired material and a fraction-bound solid phase substrate. The device includes an input zone for receiving the biological sample therein and a second, adjacent zone for receiving an isolation buffer therein. Additional zones may be provided downstream of the second zone for further processing of the fraction. Each zone is interconnected to an adjacent zone by a channel. The input of each channel is interconnected to the output of the channel by a tapered constriction such that the input of each channel has a greater cross-sectional area than the output of the channel. This arrangement insures that a stable interface is provided between each adjacent zone. A magnetic force generated by a bar magnet is used to urge the fraction-bound solid phase substrate from the input zone upstream through the channel to the second zone and beyond.

While functional for its intended purpose, the device and method disclosed in the '133 application has certain limitations. More specifically, as the fraction-bound solid phase substrate travels upstream from the input zone through the channel to the second zone, it has been found that the fraction-bound solid phase substrate has a tendency to be retained along the walls of the channel defining the tapered constriction. This, in turn, limits the ability of a user to efficiently transfer the fraction-bound solid phase substrate from one zone to an adjacent zone. Therefore, it can be appreciated that decreasing the retention of the fraction-bound solid phase substrate along the walls of the taper constriction in the channel will have a positive influence on the transfer efficiency of the fraction-bound solid phase substrate between zones.

Therefore, it is a primary object and feature of the present invention to provide a device for and a method of extracting and purifying a fraction from cultured cells, tissue samples and other biological materials.

It is a further object and feature of the present invention to provide a device for and a method of extracting and purifying a fraction from cultured cells, tissue samples and other biological materials that is simpler and more efficient than prior devices and methods.

It is a still further object and feature of the present invention to provide a device for and a method of extracting and purifying a fraction from cultured cells, tissue samples and other biological materials that has higher throughput than prior devices and methods.

In accordance with the present invention, a device is provided for facilitating extraction of a fraction from a biological sample. The fraction is bound to solid phase substrate to define a fraction-bound solid phase substrate. The device includes an input zone for receiving the biological sample therein and a second zone for receiving a fluid therein. A channel has an input in communication with the input zone and an output in communication with the second zone. A force attracts the fraction-bound solid phase substrate and is movable along a path between a first position adjacent the input zone, a second position adjacent the channel, and a third position adjacent the second zone. The force has a generally arcuate edge for concentrating the fraction-bound solid phase substrate along the path. The force urges the fraction-bound solid phase substrate from the input zone, through the channel and into the second zone as the force moves from the first position to the third position.

The fluid in the second zone is an isolation buffer, and preferably, an oil. The oil prevents the non-desired material from passing therethrough. The force is a magnetic force having a generally arcuate trailing edge and/or a generally circular cross-section. The channel includes a constriction between the input and the output thereof. The constriction is partially defined by partially defined by first and second sidewalls. The first and second sidewalls converge from the input to the output thereof. The input to the channel has a cross-sectional area and the output to the channel has a cross-sectional area. The cross-sectional area of the input of the channel is greater than the cross-sectional area of the output of the channel.

In accordance with a further aspect of the present invention, a device is provided for isolating a fraction from non-desired material in a biological sample. The fraction is bound to solid phase substrate to define a fraction-bound solid phase substrate. The device includes an input zone for receiving the biological sample therein and a second zone for receiving a fluid therein. The second zone is in fluidic communication with the input zone. A constriction interconnects the input zone and the second zone. A force captures the fraction-bound solid phase substrate and is movable along a path between a first position adjacent the input zone and a second position adjacent the second zone. The force has a generally arcuate edge for concentrating the fraction-bound solid phase substrate along the path. The force urges the fraction-bound solid phase substrate from the input zone, through the constriction and into the second zone as the force moves from the first position to the second position.

The fluid in the second zone is an isolation buffer, and preferably, an oil. The oil prevents the non-desired material from passing therethrough. The force is a magnetic force having a generally arcuate trailing edge and/or a generally circular cross-section. The constriction includes a channel having an input in communication with the input zone and an output in communication with the second zone. The channel is partially defined by partially defined by first and second sidewalls. The first and second sidewalls converge from the input to the output thereof. The input to the channel has a cross-sectional area and the output to the channel has a cross-sectional area. The cross-sectional area of the input of the channel is greater than the cross-sectional area of the output of the channel.

In accordance with a still further aspect of the present invention, a device is provided for isolating a fraction from non-desired material in a biological sample. The fraction is bound to solid phase substrate to define a fraction-bound solid phase substrate. The device includes an input zone for receiving the biological sample therein and a second zone for receiving a fluid therein. The second zone is in fluidic communication with the input zone. A constriction has an input communicating with the input zone and having a cross-sectional area and an output communicating with the second zone and having a cross-sectional area less than the cross-sectional area of the input. A force captures the fraction-bound solid phase substrate and is movable along a path between a first position adjacent the input zone and a second position adjacent the second zone. The force has a generally arcuate trailing edge for concentrating the fraction-bound solid phase substrate along the path. The force draws the fraction-bound solid phase substrate from the input zone, through the constriction and into the reaction zone as the force moves from the first position to the second position.

The fluid in the second zone is an isolation buffer, and preferably, an oil. The oil prevents the non-desired material from passing therethrough. The force is a magnetic force having a generally arcuate trailing edge and/or a generally circular cross-section. The constriction is partially defined by first and second sidewalls. The first and second sidewalls converge from the input to the output thereof.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a device in accordance with the present invention in an initial configuration;

FIG. 2 is a cross-sectional view of the device of the present invention taken along line 2-2 of FIG. 1;

FIG. 3 is a cross-sectional view of the device of the present invention, similar to FIG. 2, in the initial configuration;

FIG. 4 is an isometric view of a device of the present invention in a second configuration; and

FIG. 5 is an isometric view of the device of the present invention in a third configuration.

### DETAILED DESCRIPTION OF THE DRAWINGS

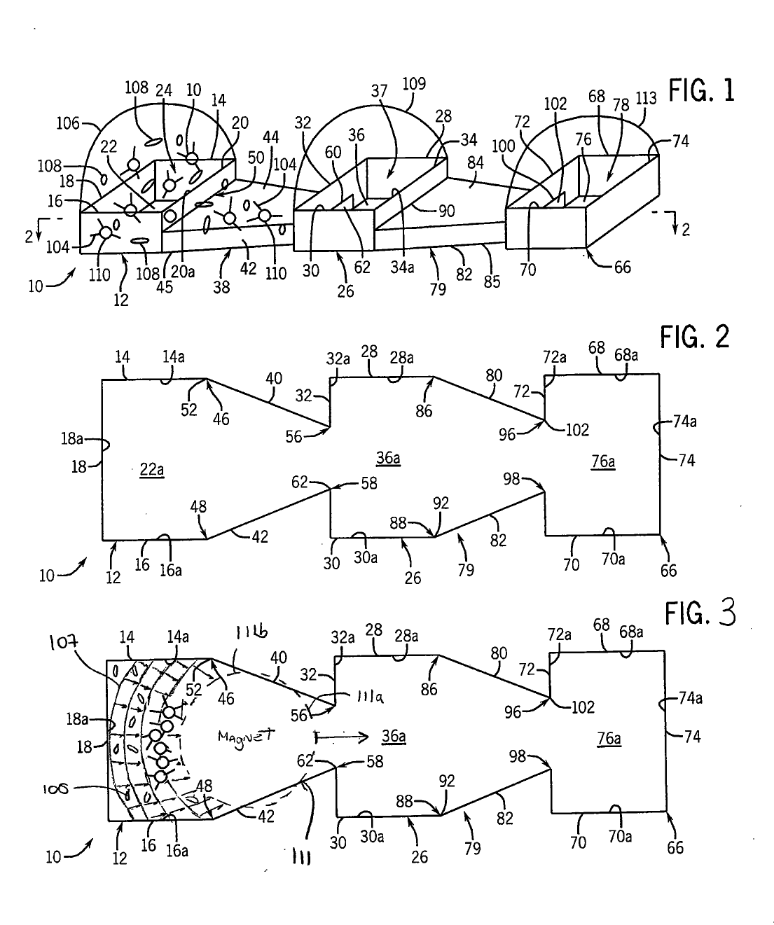

Referring to FIGS. 1-5, a device for extracting and purifying a fraction from cultured cells, tissue samples and other biological materials in accordance with the present invention is generally designated by the reference numeral 10. Device 10 includes input zone or well 12 defined by first and second sidewalls 14 and 16, respectively, first and second end walls 18 and 20, respectively, and bottom wall 22. Inner surfaces 14a and 16a of sidewalls 14 and 16, respectively, inner surfaces 18a and 20a of first and second end walls 18 and 20, respectively, and upper surface 22a of bottom wall 22 define input cavity 24 for receiving a biological sample therein, as hereinafter described. While input well 12 has a generally rectangular configuration in the depicted embodiment, other configurations are contemplated without deviating from the scope of the present invention.

Device 10 further includes second zone or well 26 downstream of input well 12 and being defined by first and second sidewalls 28 and 30, respectively, upstream wall 32, downstream wall 34 and bottom wall 36. Inner surfaces 28a and 30a of sidewalls 28 and 30, respectively, inner surface 32a of upstream wall 32, inner surface 34a of downstream wall 34, and upper surface 36a of bottom wall 36 define second cavity 37 for receiving a fluid, such as an isolation buffer, therein, as hereinafter described. Again, although second well 26 has a generally rectangular configuration in the depicted embodiment, other configurations are contemplated without deviating from the scope of the present invention.

Input well 12 and second well 26 are interconnected by first channel 38. First channel 38 extends along an axis and is defined by first and second sidewalls 40 and 42, respectively, upper wall 44 and bottom wall 45. Input ends 46 and 48 of first and second sidewalls 40 and 42, respectively, of first channel 38 and input end 50 of upper wall 44 of input channel 38 intersect end wall 20 of input well 12 so as to define input 52 to first channel 38. Output ends 56 and 58 of first and second sidewalls 40 and 42, respectively, of first channel 38 and output end 60 of upper wall 44 of first channel 38 intersect upstream wall 32 of phase-gate well 26 so as to define output 62 of first channel 38. Bottom wall 45 of first channel 38 is generally co-planar with bottom walls 22 and 36 of input well 12 and phase-gate well 26, respectively. As best seen in FIG. 2, first and second sidewalls 40 and 42, respectively, of first channel 38 converge towards each other from input 52 to output 62 so as to define a constriction in first channel 38, for reasons hereinafter described.

Device 10 further includes third zone or well 66 downstream of second well 26 and being defined by first and second sidewalls 68 and 70, respectively, upstream wall 72, downstream wall 74 and bottom wall 76. Inner surfaces 68a and 70a of sidewalls 68 and 70, respectively, inner surface 72a of upstream wall 72, inner surface 74a of downstream wall 74, and upper surface 76a of bottom wall 76 define third cavity 78 for receiving a fluid, such as a reagent, therein, as hereinafter described. Again, third well 66 has a generally rectangular configuration in the depicted embodiment, other configurations are contemplated without deviating from the scope of the present invention.

Third well 66 and second well 26 are interconnected by second channel 79. Second channel 79 extends along an axis and is defined by first and second sidewalls 80 and 82, respectively, upper wall 84 and bottom wall 85. Input ends 86 and 88 of first and second sidewalls 80 and 82, respectively, of second channel 79 and input end 90 of upper wall 84 of second channel 79 intersect downstream wall 34 of second well 26 so as to define input 92 to second channel 79. Output ends 96 and 98 of first and second sidewalls 80 and 82, respectively, of second channel 79 and output end 100 of upper wall 84 of second channel 79 intersect upstream wall 72 of third well 66 so as to define output 102 of second channel 79. Bottom wall 76 of second channel 79 is generally co-planar with bottom walls 36 and 76 of second well 26 and third well 66, respectively. As best seen in FIG. 2, first and second sidewalls 80 and 82, respectively, of second channel 79 converge towards each other from input 92 to output 102 so as to define a constriction in second channel 79, for reasons hereinafter described.

In operation, it is intended to utilize device 10 to extract fraction 104, FIG. 5, such as nucleic acids, whole cells and/or proteins, from biological sample 106. As is known, biological sample 106 may include non-desired material 108 such as lysate, bodily fluids, forensic samples, and/or biological contaminations. In order to prepare biological sample 106 for extraction of fraction 104, an appropriate reagent is added to biological sample 106 and mixed such that fraction 104 binds to a solid phase substrate 105, FIG. 5, in the reagent to form fraction-bound solid phase substrate 110. It is contemplated for the solid phase substrate to be attracted to a corresponding force. For example, the solid phase substrate may be a paramagnetic material attracted to a corresponding magnetic field. Other non-magnetic mechanisms such as gravity, ultrasonic actuation or the like are contemplated as being within the scope of the present invention. Once mixed with the reagent, biological sample 106 is deposited in input cavity 24 of input well 12; isolation buffer 109, such as oil or wax, is deposited in second cavity 37 of second well 26; and a desired reagent 113 is deposited in third cavity 78 of third well 66. It can be appreciated that the mixing of biological sample 106 and the reagent may occur in input cavity 24 of input well 12 and/or first channel 38 without deviating from the scope of the present invention.

Device 10 of the present invention relies upon the dominance of surface tension over gravity at the microscale to establish “virtual walls” between each fluid interface. This dominance of surface tension enables the side-by-side loading of fluids in device 10 that is not possible on the macroscale. This phenomenon is quantified by the dimensionless Bond number:

Bo=ρgL2/γ Equation (1)

wherein: Bo is the Bond number; ρ is the density of a fluid; g is the acceleration of gravity; L is a characteristic length scale of the device; and γ is the surface energy of the fluid.

A Bond number (Bo) less than 1 indicates a system in which surface tension forces are sufficiently large to marginalize the effects of gravity. For larger Bond number (Bo) devices, gravity dominance mandates positioning of the denser biological sample in input well 12 and reagent in third well 66 below the isolation buffer in second well 26, constraining device geometry into a three-dimensional architecture. Because Bond number (Bo) scales with the square of the characteristic length scale of the device (L²), a reduction in device dimensions rapidly reduces the Bond number (Bo) into the surface tension-dominant regime. Microfluidic constrictions, such as first and second channels 38 and 79, respectively, as heretofore described, with very small characteristic length scales selectively impede liquid motion, enabling serial loading of all three device fluids (the biological sample, the isolation buffer and the reagent) into their respective wells (input well 12, second well 26 and third well 66, respectively) without intermixing or density-driven stratification. Hence, the reliance upon the dominance of surface tension, allow for the planarization of the layout of the devices of the present invention which, in turn, simplifies both device fabrication and operation while also enabling high-throughput arrays in well plate-like configurations.

In view of the foregoing, it is noted that the cross-sectional area of input 52 to first channel 38 is greater than the cross-sectional area of output 62 of first channel 38 so as to form a constriction in first channel 38. As a result, biological sample 106 flows into first channel 38 through input 52 thereof. However, the surface tension of isolation buffer 109 in second cavity 37 of second well 26 at output 62 of first channel 38 prevents biological sample 106 from flowing into second cavity 37 of second well 26 through output 62 of first channel 38. Likewise, the surface tension of reagent 113 in third cavity 78 of third well 66 at output 102 of second channel 79 prevents isolation buffer 109 from flowing into third cavity 78 of third well 66 at output 102 of second channel 79.

In order to extract fraction-bound solid phase substrate 110 from biological sample 106, a force to which solid phase substrate 105 is attracted is positioned adjacent, and in the depicted embodiment, below input well 12. As heretofore described, it is contemplated for solid phase substrate 105 to be a paramagnetic material attracted to a corresponding magnetic field. By way of example, in order to generate the magnetic field, magnet 111 is positioned below input well 12 such that fraction-bound solid phase substrate 110 is magnetically attracted thereto, FIG. 3. In the depicted embodiment, magnet 111 is generally circular with generally arcuate leading and trailing edges 111a and 111b, respectively. Magnet 111 generates a magnetic field, generally designated by the reference numeral 107, having a gradient directed toward the interior of input well 12. The inward angle of the magnetic field gradient induces a concentration of fraction-bound solid phase substrate 110 at the center of input well 12, FIG. 3.

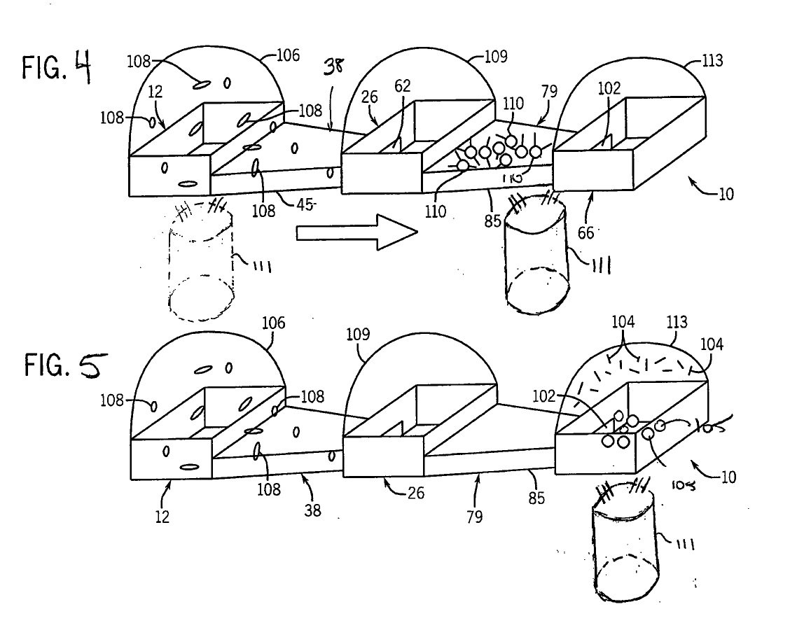

As is known, fraction-bound solid phase substrate 110 develop magnetic dipoles in response to magnetic field 107 imposed thereon. As a result, the magnetic dipoles of fraction-bound solid phase substrate 110 align with and are drawn to magnetic field 107 such that fraction-bound solid phase substrate 110 may be moved in response to the movement of magnet 111. As such, with fraction-bound solid phase substrate 110 concentrated at the center of input well 12, as heretofore described, magnet 111 is moved sequentially to a position: 1) below bottom wall 45 of first channel 38 such that magnetic field 107 draws fraction-bound solid phase substrate 110 into first channel 38 through input 52 thereof; 2) below bottom wall 36 of second well 26 such that magnetic field 107 draws fraction-bound solid phase substrate 110 into second well 26 through output 62 of first channel 38; 3) below bottom wall 85 of second channel such that magnetic field 107 draws fraction-bound solid phase substrate 110 into second channel 79 through input 92 thereof, FIG. 4; and 4) below bottom wall 76 of third well 66 such that magnetic field 107 draws fraction-bound solid phase substrate 110 into third well 66 through output 102 of second channel 79, FIG. 5.

With fraction-bound solid phase substrate 110 concentrated along the path of the magnetic field 107, the frictional drag experienced by fraction-bound solid phase substrate 110 from first and second sidewalls 40 and 42, respectively, of first channel 38 is reduced as fraction-bound solid phase substrate 110 pass therethrough. Reducing the frictional drag experienced by fraction-bound solid phase substrate 110 has a positive influence on transfer efficiency as there will be a greater number of fraction-bound solid phase substrate 110 amassed at the interface of biological sample 106 and isolation fluid 109. With fraction-bound solid phase substrate 110 concentrated at the interface of biological sample 106 and isolation fluid 109, macroscopic three-dimensional superstructures may form in the presence of magnetic field 107. These macroscopic three-dimensional superstructures have a greater mass than individual fraction-bound solid phase substrate 110. As such, the strength of magnetic force necessary to overcome surface tension at the interface of biological sample 106 and isolation fluid 109 is reduced so as to increase the likelihood of complete transfer of fraction-bound solid phase substrate 110 from first channel 38 to second well 26.

Similarly, the frictional drag experience by fraction-bound solid phase substrate 110 from first and second sidewalls 80 and 82, respectively, of second channel 79 is reduced as fraction-bound solid phase substrate 110 pass therethrough. With fraction-bound solid phase substrate 110 concentrated at the interface of isolation fluid 109 and reagent 113, the greater mass of fraction-bound solid phase substrate 110 passes more easily through the interface of isolation fluid 109 and reagent 113 so as to increase the likelihood of complete transfer of fraction-bound solid phase substrate 110 from second channel 79 to third well 66.

As previously noted, the surface tension of isolation buffer 109 in second cavity 37 of second well 26 at output 62 of first channel 38 prevents biological sample 106 from flowing into second cavity 37 of second well 26 through output 62 of first channel 38 and the surface tension of reagent 113 in third cavity 78 of third well 66 at output 102 of second channel 79 prevents isolation buffer 109 from flowing into third cavity 78 of third well 66 at output 102 of second channel 79. It can be appreciated that as fraction-bound solid phase substrate 110 pass through second well 26 and second channel 79, fraction-bound solid phase substrate 110 are washed by isolation buffer 109 therein, thereby effectively isolating fraction-bound solid phase substrate 110 from the remainder of biological sample 106. With fraction-bound solid phase substrate 110 isolated from the remainder of biological sample 106 in third well 66, fraction-bound solid phase substrate 110 may be treated in third well 66 by reagent 113 contained therein as desired by a user. In addition, it can be appreciated that third well 66 may be operatively connected to additional downstream components for further processing of fraction-bound solid phase substrate 110. Further, it is contemplated for reagent 113 in third well 66 to be an elution buffer such that fraction 104 bound to the solid phase substrate may be extracted therefrom, FIG. 5.

It is also noted that it contemplated as being within the scope of the present invention to provide an array of the devices as heretofore described in combination with an array of permanent magnets in a 1:1 ratio. Alternatively, an array of electromagnets may be utilized to provide adaptable and programmable movement of a magnetic field, as heretofore described, with no moving parts. Further, it can be appreciated that either magnet 111 or device 10 of the present invention can be the movable part, without deviating from the scope of the present invention.

Various modes of carrying out the invention are contemplated as being within the scope of the following claims particularly pointing out and distinctly claiming the subject matter, which is regarded as the invention.

1. A device for isolating a fraction from non-desired material in a biological sample, the fraction being bound to solid phase substrate to define a fraction-bound solid phase substrate, the device comprising:
an input zone for receiving the biological sample therein;
a second zone for receiving a fluid therein;
a channel having an input in communication with the input zone and an output communicating with the second zone; and
a force attracting the fraction-bound solid phase substrate and being movable along a path in a direction of travel between a first position adjacent the input zone, a second position adjacent the channel, and a third position adjacent the second zone, the force including a source for generating a generally arcuate field extending radially away from the source and being defined by a plurality of forces lines directed towards a trailing edge of the source and towards the path, the plurality of force lines acting to concentrate the fraction-bound solid phase substrate at the trailing edge of the source adjacent the path;
wherein:
the force draws the fraction-bound solid phase substrate from the input zone, through the channel and into the second zone as the force moves from the first position to the third position.

2. The device of claim 1 wherein the fluid in the second zone is an isolation buffer.

3. The device of claim 2 wherein the isolation buffer is an oil, the oil preventing the non-desired material from passing therethrough.

4. The device of claim 1 wherein the force is a magnetic force.

5. The device of claim 4 wherein the source is a magnet and wherein the trailing edge is arcuate.

6. The device of claim 4 wherein the source is a magnet, the magnet having a generally circular cross-section.

7. The device of claim 1 wherein the channel includes a constriction between the input and the output thereof.

8. The device of claim 1 wherein the channel is partially defined by partially defined by first and second sidewalls, the first and second sidewalls converging from the input to the output thereof.

9. The device of claim 1 wherein the input to the channel has a cross-sectional area and the output to the channel has a cross-sectional area, the cross-sectional area of the input of the channel being greater than the cross-sectional area of the output of the channel.

10. A device for isolating a fraction from non-desired material in a biological sample, the fraction being bound to solid phase substrate to define a fraction-bound solid phase substrate, the device comprising:
an input zone for receiving the biological sample therein;
a second zone for receiving a fluid therein, the second zone being in fluidic communication with the input zone;
a constriction interconnecting the input zone and the second zone; and
a force capturing the fraction-bound solid phase substrate and being movable along a path between a first position adjacent the input zone and a second position adjacent the second zone, the force including a source for generating a generally arcuate field extending radially away from the source and being defined by a plurality of forces lines directed towards a trailing edge of the source and towards the path, the plurality of force lines acting to concentrate the fraction-bound solid phase substrate at the trailing edge of the source adjacent the path;
wherein:
the force draws the fraction-bound solid phase substrate from the input zone, through the constriction and into the second zone as the force moves from the first position to the second position.

11. The device of claim 10 wherein the fluid in the second zone is an isolation buffer.

12. The device of claim 11 wherein the isolation buffer is an oil, the oil preventing the non-desired material from passing therethrough.

13. The device of claim 11 wherein the force is a magnetic force.

14. The device of claim 13 wherein the source is a magnet and wherein the trailing edge is arcuate.

15. The device of claim 11 wherein the source is a magnet, the magnet having a generally circular cross-section.

16. The device of claim 10 wherein the constriction includes a channel having an input communication with the input zone and an output communicating with second zone.

17. The device of claim 16 wherein the channel is partially defined by first and second sidewalls, the first and second sidewalls converging from the input to the output thereof.

18. The device of claim 16 wherein the input to the channel has a cross-sectional area and the output to the channel has a cross-sectional area, the cross-sectional area of the input of the channel being greater than the cross-sectional area of the output of the channel.

19. A device for isolating a fraction from non-desired material in a biological sample, the fraction being bound to solid phase substrate to define a fraction-bound solid phase substrate, the device comprising:
an input zone for receiving the biological sample therein;
a second zone for receiving a fluid therein, the second zone being in fluidic communication with the input zone;
a constriction having an input communicating with the input zone and having a cross-sectional area and an output communicating with the second zone and having a cross-sectional area less than the cross-sectional area of the input; and
a force capturing the fraction-bound solid phase substrate and being movable along a path between a first position adjacent the input zone and a second position adjacent the second zone, the force including a source for generating a generally arcuate field extending radially away from the source and being defined by a plurality of forces lines directed towards a trailing edge of the source and towards the path, the plurality of force lines acting to concentrate the fraction-bound solid phase substrate at the trailing edge of the source adjacent the path;
wherein:
the force draws the fraction-bound solid phase substrate from the input zone, through the constriction and into the reaction zone as the force moves from the first position to the second position.

20. The device of claim 19 wherein the fluid in the second zone is an isolation buffer.

21. The device of claim 20 wherein the isolation buffer is an oil, the oil preventing the non-desired material from passing therethrough.

22. The device of claim 19 wherein the force is a magnetic force.

23. The device of claim 22 wherein the source is a magnet and wherein the trailing edge is arcuate.

24. The device of claim 22 wherein the source is a magnet, the magnet having a generally circular cross-section.

25. The device of claim 19 wherein the constriction is partially defined by first and second sidewalls, the first and second sidewalls converging from the input to the output thereof.
